(19) United States
(12) Patent Application Publication
(10) Pub. No.: US 2004/0059953 A1
(43) Pub. Date: Mar. 25, 2004

(54) Methods and systems for identity management

(75) Inventor: John Purnell, Annapolis, MD (US)

Correspondence Address: OLIFF & BERRIDGE, PLC, P.O. BOX 19928, ALEXANDRIA, VA, 22320, US

(73) Assignee: ARINC, Annapolis, MD

(21) Appl. No.: 10/665,419

(22) Filed: Sep. 22, 2003

Related U.S. Application Data
(60) Provisional application No. 60/412,798, filed on Sep. 24, 2002.

(51) Int. Cl. H04L 9/32

(52) U.S. Cl. 713/202; 382/115

(57) ABSTRACT

This invention provides systems and methods for the processing and handling of enrollment, authentication, and subsequent verification of the identity of passengers and employees or workers in the transportation industry by pre-enrolling the individual to collect, among other things, personal information. The collected information is vetted through a series of background checks. Upon satisfactory completion of the background checks, the individual is enrolled into the system and is issued an identity token.

### CROSS-REFERENCE TO RELATED APPLICATIONS

This Application claims priority from U.S. Provisional Application No. 60/412,798, filed Sep. 24, 2002. The entire disclosure of the provisional application is incorporated herein by reference.

### BACKGROUND OF THE INVENTION

1. Field of Invention

This invention relates to identity management of workers, employees and travelers in the transportation industry. More specifically, this invention relates to methods and systems for verifying the identity of passengers using various modes of transportation, and verifying the identity of employees and workers of the transportation industry.

2. Description of Related Art

Currently, employees and workers submit an application to become authenticated for access to individual transportation facilities, such as air terminals, train terminals, ship terminals, and the like. The application process may include fingerprinting and/or some document checks for proof of identity, employment status, immigration status, function of the individual, and the like. Many known access control systems do not use any biometric data to authenticate a worker at an entry point to the secured areas of the transportation facility. However, biometric data is used for identifying individuals as discussed below. The information provided in this application is forwarded to various law enforcement agencies, such the FBI or the INS, for background checking of the individual. The background checking process can take three or more weeks to complete for each individual worker or employee. When the results of the background check are returned, each transportation facility authority makes a decision regarding the access privileges to be granted to each individual worker or employee, and effectuates those decisions through an access control system.

Also, transportation workers must be authenticated by each individual transportation facility where they might need to work. Since transportation workers and employees are inherently mobile, the need to authenticate such workers and employees at various facilities leads to numerous duplicate registrations which results in a loss of time and resources. Because a worker or employee may not be present at a particular transportation facility for some time, authorities are not always aware of the access status of a particular worker or employee. As a result, a worker may be incorrectly granted access privileges to secure areas of a transportation facility.

Travelers receive considerably less authentication than workers or employees at and/or by a transportation facility. Travelers are typically subjected to a cursory visual examination of a passport or identity token issued by one of the U.S. states, such as a drivers license. Travelers may also be subjected to visual inspection of transportation boarding documents or itineraries to further prove their identity, depending upon the need for entry into secured areas of the transportation facility, such as boarding areas, baggage claim, the actual means of transportation, and the like. Visual inspection is labor intensive, expensive and unreliable.

An example of the use of biometric data as a means for identifying an individual may be found in U.S. Pat. No. 6,424,249 that provides a system and method for secure identification of a system user to limit access to only authorized personnel. The system provides system integrity and audit capabilities to a positive identification system by including biometric user authentication. The method and system utilizes an automated biometric comparison system to limit access to the identification database and the information contained therein to personnel who are authorized to do so. The system includes a point of identification terminal having a means for inputting biometric access authority information unit from a system user; a means for inputting identifying information presented by a particular individual; at least one database storage and retrieval site having stored therein a plurality of digital image data unique to persons to be identified; and a biometric access authority information unit database, including biometric data associated with authorized system users. The system provides a means for receiving biometric information, such as fingerprints, which is transmitted to the remote database site. The remote site receives the biometric data and searches a database to determine if a match exists between the received information and the stored information. If a match exists, then the system user is permitted to input information presented by a person to be identified at the point of identification terminal into the system. The point of identification terminal then transmits the information to the remote database site where the system searches the database of digital photographic images and retrieves the photograph associated with the identifying information. The retrieved information is then returned to the point of identification terminal where it is displayed on a display device and the user is positively identified.

U.S. Pat. No. 6,119,096 discloses a system and method for automated aircraft boarding that uses an iris recognition system for check-in and boarding. The passenger is enrolled once and assigned an account number. The passenger makes reservations using that account number and, upon arrival at the airport, is identified using an iris recognition system and automatically checked in for the flight, without the use of cards or other identification. Entry to the aircraft at the gate may also be provided with an iris recognition station. In one preferred embodiment, baggage check and baggage reconciliation are also performed using iris recognition. In its preferred embodiment, the disclosed system and method enhances customer convenience by eliminating tickets, boarding passes, and identification steps, while improving aircraft security.

Other known identification systems involve forwarding biometric data to the INS, and fingerprint identification systems via a smart card. These systems do not allow for matching the identity of an individual with law enforcement or immigration databases. Such systems also do not allow for control of the status and authentication of transportation facility workers and employees. Furthermore, such systems do not contemplate use with a large number of temporary visitors such as travelers in a transportation facility.

Thus, none of these systems provide for positive biometric-based identification of a worker, employee or traveler in a transportation facility, a check of that individual using law enforcement and immigration databases, and a verification of that individual's access status, i.e., whether the individual is cleared to access a given area in general and/or at a given time, via an identification card and/or biometric data.

### SUMMARY OF THE INVENTION

In response to the need for greater security at transportation facilities, the methods and systems according to this invention provide a system and associated process, as well as software, for fast, simple verification and authentication of the identity of workers, employees, travelers, visitors, and the like, at transportation facilities or other facilities where there is a need for identity management and access status of individuals. As used in this application, an employee is typically a person who is employed on a permanent basis at the transportation facility, such as a maintenance person, a checking agent, and the like. On the other hand, a worker can be a person temporarily working in the transportation facility, such as an independent contractor, delivery person, and the like.

In an exemplary embodiment of the methods and systems of this invention, an individual pre-enrolls by submitting an application for an identity management system token. The identification token may be a “smart card”, identification card, i.e., driver's license, credit card, etc., boarding pass, passport, and the like. The pre-enrollment application may be presented personally by the individual at a transportation facility or other location, may be completed and admitted via the internet, or mailed to the transportation facility. Filing an application, whether personally, over the internet or by mail, constitutes pre-enrollment.

An exemplary embodiment of the methods and systems of this invention includes the use of one or more workstations on which different tasks are performed. An enrollment workstation is used to enroll applicants into the identity management system once pre-enrollment and preliminary authentication are complete. A vetting workstation is networked to systems used to perform background checks of individuals. A security workstation is used to check the identity of an individual at various locations in the transportation facility. A dispatch workstation is used by employers of transportation workers to verify that an individual has a need to access a secure area, as well as track movements of individuals within a transportation facility. A check-in workstation, which may be operated by transportation facility personnel, allows an individual to check-in and obtain a boarding pass and luggage tags. Each of the one or more workstations are securely connected via a network to a core system, which serves as the central clearinghouse for all identity management activity.

During pre-enrollment, the applicant provides personal identification data and may agree to certain contractual terms and requests certain levels of access. In the case of a transportation facility worker or employee, the individual may also be required to visit the nearest transport facility, or other authorized location, to submit a biometric data sample, such as a fingerprint, facial image, iris scan, hand geometry, voice print, and the like, for more extensive vetting.

After pre-enrollment is completed, the identity of the individual is verified through a preliminary authentication step. The authenticated personal data submitted by the individual during pre-enrollment, and the requested access privileges are entered and then transmitted and stored in the core system. In dealing with a transportation facility worker or employee, the fingerprints, facial image, or other biometric samples submitted during pre-enrollment may be collected and later used for more exhaustive background checks.

Once the authentication step has been completed and approved, the individual may be notified to proceed to enrollment. The individual may then visit a transportation facility, or other authorized location, and, if required or desired, bring further identification documentation for enrollment. Such documents may include, for example, passports, birth records, drivers license, and the like. The documents presented during enrollment may be verified by an agent against the initial pre-enrollment application data stored in the core system. Biometric data such as facial image, voice recording, fingerprints, iris scan, hand geometry, and the like, may also be collected at the enrollment workstation. In an exemplary embodiment of the invention, two types of biometric data will be collected from the individual. The first type, operational biometric data, is biometric data that is easily obtainable and verifiable, such as a facial image, and will allow for fast and easy identification of a large number of people, for instance, in an airport. The second type of biometric data, reference biometric data, such as an iris scan, may be submitted only in case when doubt arises as to the true identity of an individual when identification is being verified.

After the additional identification documentation is obtained and entered into the system, the information is available to the proper agencies through the vetting workstation to conduct background checks.

In an exemplary embodiment of the invention, an identity token may be issued at the enrollment workstation upon successful completion of the background checks. The token may contain identity, as well as biometric data, encoded on or in it. Other tokens, such as a drivers license or passport, for example, may be approved for use in the identity management system.

In the case of managing the identity of transportation facility employees or workers, an identity token may also replace company or port issued identification badges and, in virtue of the information encoded in it, may eliminate duplicate registrations and background checks, thus saving time and expense. The enrollment workstation may also be interfaced to local transportation facility access control systems to ensure that only enrolled and satisfactorily vetted employees or workers can have access to secure areas during a given period of time. For instance, a pilot may not be allowed to board a plane if the plane is not scheduled to take off during the period of time during which the pilot requests access to the plane.

Once a traveler has been enrolled, properly vetted, and has obtained an identity token, the traveler may check-in using a check-in workstation or check-in kiosk. Verification of the identity of the individual is carried out by comparing information stored in the core system to information provided by the individual at the check-in workstation or check-in kiosk. Unlike conventional check-in stations, the check-in workstation or check-in kiosk, in an exemplary embodiment of this invention, biometrically identifies the individual as the individual that was originally enrolled and compares the operational biometric data provided by the individual to the data that may be encoded on the identity token.

In another exemplary embodiment of this invention, for travelers only, a transportation facility agent swipes the identity token using the identity token scanner and accesses travel information, such as itinerary and travel schedule, from a transportation facility database to which the check-in workstation is securely connected to through a link or a network.

Once a worker or employee has enrolled and has obtained an identity token, a dispatch workstation is used by the transportation facility to verify that an individual is an employee of the transportation company, and does have a need to access a secure facility during a given period of time. The dispatch workstation also requires that an individual biometrically identify themselves to conduct a transaction, such as gain access to a secured area. The dispatch workstation may also record and track the use of the token to track the movement and present location of workers and employees in a transportation facility.

An enrolled individual having an identity token may pass through a security workstation and does not need any other identification document other than the issued identity token. The security workstation can securely access information stored in a memory of the core system, and verify that information against the information read on the identity token and the biometric data provided by the individual at the security workstation.

In an additional exemplary embodiment of this invention, a passenger boarding step is included where a boarding workstation is used. The boarding workstation allows for the biometric identification of a passenger prior to boarding an aircraft, or other means of transportation, and allows access of travel information of the individual. The identification token is used to allow the passenger to board the transportation vehicle without showing any further identification.

In another exemplary embodiment of this invention, tracking of travelers such as foreign nationals can be performed when, for instance, foreign nationals apply for an entry visa to the U.S. The foreign national may be asked to provide preliminary information which may be authenticated at an foreign-located outpost of the FBI or the like. The foreign national may then physically present themselves at the U.S. embassy and provide biometric data. An identity token may then be issued to the foreign national or stamped, if the token is the foreign national's passport, which will be used in tracking the foreign national when they enter the U.S. Use of the token at check-in, security workstation check points, boarding workstations, etc. can be tracked and recorded. Thus, the movement of such foreign nationals through transportation facilities may be monitored.

The systems described above are interconnected through a core system using secured connections. The core system serves as the central processing clearinghouse for all identity management activity. The identity and travel data, transmitted to and stored in the core system, constitute the permanent tracking record of an individual and is maintained in the core system and stored in a memory of the core system. This data may be encrypted and made accessible only to authorized individuals through a secure link or network. The core system, securely networked with the other workstations described above and to an identity management engine, allows for the tracking of an individual from the moment they enter the transportation facility to the moment they leave it. Undue delays during this process can be noticed, and unusual behavior such as checking-in luggage without boarding, can also be detected.

### BRIEF DESCRIPTION OF THE DRAWINGS

Various exemplary embodiments of the systems and methods according to this invention will be described in detail with reference to the following figures, wherein:

FIG. 1 is a schematic view of an exemplary embodiment of the systems invention showing an arrangement of a plurality of workstations;

FIG. 2 is a flowchart illustrating an exemplary method of the identity management system according to this invention;

FIG. 3 is a flowchart illustrating an exemplary method of a passenger/employee pre-enrollment step according to this invention;

FIG. 4 is a flowchart illustrating an exemplary method of a passenger/employee enrollment step according to this invention;

FIG. 5 is a flowchart illustrating an exemplary method of an authentication step according to this invention;

FIG. 6 is a flowchart illustrating an exemplary method of a check-in step according to this invention;

FIG. 7 is a flowchart illustrating an exemplary method of a security check step according to this invention; and

FIG. 8 is a flowchart illustrating an exemplary method of a boarding step according to this invention.

### DETAILED DESCRIPTION OF PREFERRED EMBODIMENTS

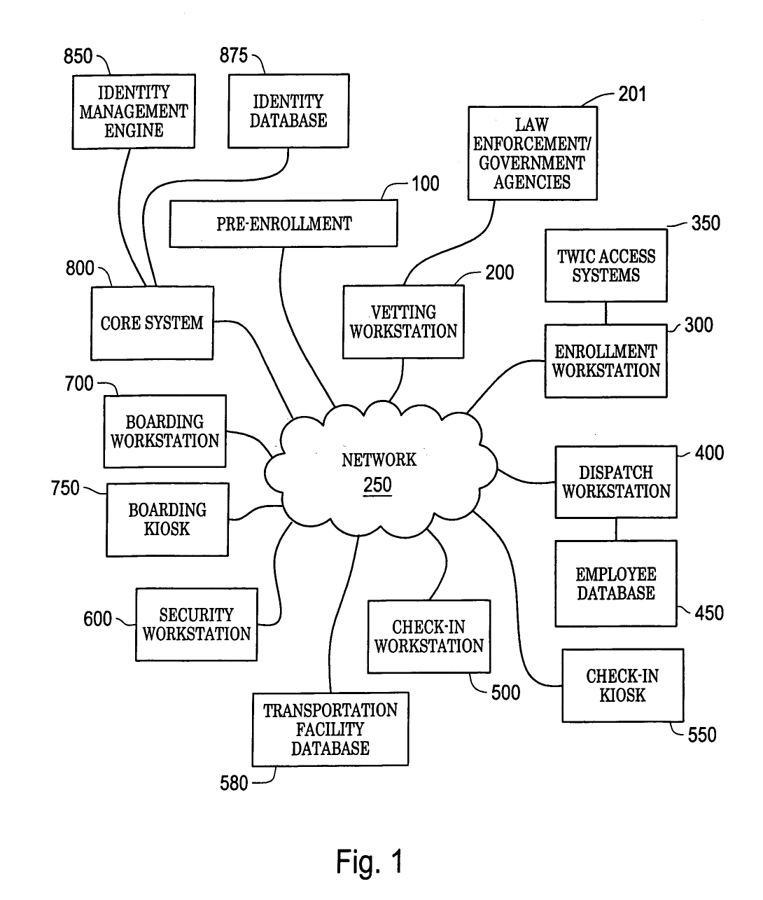

FIG.1 shows a schematic view of an exemplary embodiment of the identification management system according to this invention, including pre-enrollment system 100, a vetting workstation 200, an enrollment workstation 300, a dispatch workstation 400, a check-in workstation 500, a security workstation 600, a boarding workstation 700, and a core system 800.

Each workstation is interconnected to the core system through a secure network 250. The core system 800 includes an identity management engine 850 and an identity database 875 which are securely connected to the other workstations with the help of secure encrypted systems such as, for example, the Public Key Infrastructure (PKI) encryption system.

In an exemplary embodiment of the invention, an individual, whether a traveler, transportation facility worker or employee, pre-enrolls in the identification management system by submitting an application including personal data, such as name, date of birth, address, citizenship, and the like, answering a few questions, agreeing to contractual terms and requesting specific access privileges. The questions asked to the individual may focus on “out of wallet” topics, i.e., the questions cannot be answered by looking up the information typically present in an individual's wallet, such as an individual's date of birth or credit card number.

In an exemplary embodiment of this invention, the “out of wallet” questions pertain to some personal financial information such as the exact mortgage payment, whether the individual has a checking account in a given bank, the individual's mother's maiden name, and the like. The submission of such information can be done either personally by the individual, by mail, or via the Internet.

In the case of a transportation facility employee or worker, the individual may be required to submit this information personally. The transportation facility employee or worker may also be required to present a biometric sample such as a fingerprint, facial image, iris scan, hand geometry, voice print, and the like, during pre-enrollment. The information submitted during pre-enrollment is entered into the pre-enrollment system 100 and is transmitted via the secure network 250 to the core system 800 and stored in a memory of the core system 800.

The memory of the core system 800 can be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writable or re-writeable optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

Once the personal information is entered into the system, the individual may be notified to proceed to enrollment.

The enrollment workstation 300 is interconnected to the core system 800 through the network 250. The enrollment workstation 300 is used to enroll an individual into the system once pre-enrollment 100 is satisfactorily completed. In an exemplary embodiment of this invention, the enrollment workstation 300 may consist of a computer, a display screen and a printer operated by an agent. A biometric data collection device, such as a voice recorder, a fingerprint scanner, an iris scanner, a camera and the like, is also included. The secure link or network 250 between the enrollment workstation 300 and the core system 800 is provided for secure bi-directional communication.

The pre-enrolled individual visits an enrollment workstation 300 at a transportation facility, or other authorized location, and brings documentation, such as passports, birth records, driver's license, or the like. In an exemplary embodiment of this invention, a document scanner, operated by an agent, may be used to scan the documentation and/or personal data brought by the individual and transmit that information to the core system 800 to be stored in a memory of the core system 800. The content of these documents is verified against the initial pre-enrollment application data stored in the core system 800 by accessing the core system 800 from the enrollment workstation 300.

Biometric samples may also be collected from the applicant at the enrollment workstation 300. The biometric data, such as a fingerprint, an iris scan, hand geometry, a facial image or the like, may be collected by an agent using a biometric data collector, such as a fingerprint scanner, a camera, an audio/video recorder, an iris scanner, and the like, is used to verify the identity of the individual during the vetting process and/or during routine security checks, check-in and boarding, as described below. This biometric data, as well as any new documentation brought by the individual, are transmitted to the core system 800 over the secure network 250 and stored in a memory as part of the permanent record of the individual. i The permanent record of the identity of the individual provides a record against which future authentication can be performed. The record, stored in a memory of the core system 800, also allows access and tracking of this information from other workstations over the secure network 250 during other stages of the identity management system.

In the case of a transportation facility worker or employee, biometric samples submitted by the individual, such as fingerprints and facial image for instance, are matched with the personal data submitted during pre-enrollment 100. The matched samples and personal data are transmitted via the secure network 250 and stored in a memory of the core system 800, and used for more exhaustive background and/or security checks during vetting by law enforcement/government agencies 201.

Once the proper documentation is provided, the applicant is vetted. The vetting workstation is also linked to local and/or federal government agencies, or other background/security checking authorities 201, to manage the process of conducting background checks by those agencies.

In an exemplary embodiment of this invention, the vetting workstation 200 may comprise a computer, a display screen and printer operated by an agent connected to the core system 800 via the secure network 250 to retrieve the data stored in a memory of the core system 800 provided by the individual during pre-enrollment and enrollment. The vetting workstation 200 is securely connected over the network 250 to a number of agencies 201, such as the FBI, INS, ATF, Interpol, or any other relevant organization that conduct background and/or security checks. The identity data, provided during pre-enrollment 100 and enrollment and stored in a memory of the core system 800, is verified against, for instance, the above-mentioned data sources and background checks are performed by those agencies. The identity information is transmitted to those agencies 201 over the secure network 250.

Once the background and/or security check is performed, the results are transmitted from the agencies 201 over the secure network 250 for storage in memory of the core system 800 and may be displayed on a screen of the vetting workstation 200.

The vetting workstation 200 is also securely connected to the core system 800 via the network 250. The core system 800 acts as a central data server, or central clearinghouse, where the data collected by the vetting workstation 200 is stored in a memory. For example, data from pre-enrollment 100 and information received during the vetting process that have been transmitted to and stored in a memory of the core system are made available securely through the network 250 to allow the other above-mentioned workstations access.

Upon satisfactory completion of the vetting process, an identification card, or identity token, is issued to the individual at the enrollment workstation 300. In an exemplary embodiment, the identity token may have biometric and identity data encoded on it for use by the identity management system to authenticate the identity of the individual. The information contained in the identity token, once read through an identity token scanner for instance, and the biometric data submitted by the individual, can be verified against the information that was stored in a memory of the core system 800 during the authenticating step from any workstation securely connected over the secure network 250 to the core system 800.

For example, when managing the identity of transportation facility employees or workers, the identity token may be in the form of a Transportation Worker Identification Card (TWIC). The identity token may replace company identification badges and, by virtue of the information encoded in it, may eliminate duplicate registrations and background checks, thus saving time and expense.

In an exemplary embodiment of the invention, the enrollment workstation 300 may be interfaced to transport facility access system 350 to control access or passage through certain doors in the transportation facility to ensure that only authorized employees or workers can have access to specific areas. Thus, only employees or workers that are enrolled, satisfactorily vetted and with a specific purpose during a given period of time will be allowed into certain areas of the facility at that time. Former employees who have been satisfactorily vetted, or employees on leave or assigned to other areas of the facility, will not be allowed to access predetermined areas of the facility unless they need to access an area at a given time and they are cleared to do so by the transportation facility management. For example, a pilot may not be granted access to the cockpit of an airplane if the airplane is not scheduled to take off during the period of time that the pilot is requesting access, and if that pilot is not recognized as being the pilot of the airplane for that particular flight.

As shown in FIG. 1, the dispatch workstation 400 is interconnected to the core system 800 through the network 250. The dispatch workstation 400 allows an employer or facility official to verify that an individual is an employee of the company, and has a need to access certain areas within a facility, by accessing and collecting employee data from an employee database 450.. The information from the employee database 450 may be compared with the information on the individual stored in the core system 800 to which it is securely connected through the network 250.

In an exemplary embodiment of this invention, the dispatch workstation 400 may consist of a computer, a display screen and a printer used by an agent or stand-alone, an identity token scanner to read the information encoded in the identity token, a biometric data collection device such as a voice recorder, a fingerprint scanner, an iris scanner, and the like, and a secure link or network to the core system 800 to access information stored in a memory of the core system 800 and determine if the individual is cleared to and has a need to access a secure area of the transportation facility.

In an exemplary embodiment, when an employee swipes the identity token through a scanner to gain access to a certain area of the facility, verification of the individual's employee status is performed through the query of the employee database 450 to which the dispatch workstation 400 is securely connected through the network 250. The employee information, such as employee name and number and location assignment, is accessed by the dispatch workstation 400 through a query of the employee database 450 through the secure network 250, is compared to and verified against the data stored in a memory of the core system 800 during pre-enrollment, enrollment and vetting, and accessed from the core system 800 through the dispatch workstation 400. The data, relative to an employee's status, will be used to confirm or deny the employee's need to access a certain area of the facility by determining if the worker is cleared to access the area. The dispatch workstation may also record and track the use of the token to track the movement and present location of workers and employees in a transportation facility.

With the identity token issued during enrollment, an individual can be instantly recognized as a registered passenger, a worker or an employee, throughout any transportation facility using the identity management system, every time the individual presents the token at a workstation to an agent or swipes the token directly at an automated kiosk. The information read by the identity token scanner may be verified against the other identity information already stored in the core system 800 during earlier steps of the identity management system. The information read in the identity token and that accessed in the core system 800 are also compared to the biometric data provided by the individual at the workstation or the kiosk.

In another exemplary embodiment of the invention, the dispatch workstation 400 may issue dispatch notices. Dispatch notices are regularly updated employee assignment notices to inform the identity management system of the reasons, locations and duration of an employee's need for access to certain areas of the facility. These notices are transmitted and stored in a memory of the core system 800 and/or employer database via the secure network 250 to allow access and tracking of this information and the individual from other workstations during this and other stages of the identity management system. The dispatch workstation 400 may be interfaced to additional employee dispatch systems, such as airline crew management systems, for automatic generation of dispatch notices. This information will be part of the permanent tracking record of the employee or worker, transmitted to and stored in a memory of the core system 800 through the secure network 250 and accessible from any workstation via the secure network 250.

The check-in workstation 500 is interconnected to the core system 800 through the network 250. The check-in workstation 500 is used to allow an individual, such as a traveler, to check their luggage, obtain a boarding pass and luggage tags, and the like, based on the information provided in the identity token when the token is scanned through an identity token scanner at a workstation or kiosk.

In an exemplary embodiment of this invention, the check-in workstation 500 may consist of a computer, a display screen and a printer operated by an agent to issue luggage tags and boarding passes, an identity token scanner to read the information encoded in the identity token, and a biometric data collection device, such as voice recorder, a fingerprint scanner, an iris scanner, and the like. The check-in workstation 500 may also include an agent recording the biometric data and querying the core system 800 to verify the identity of the individual. Reservation and travel information stored in a transportation facility database 580 may be accessed from the check-in workstation 500 and displayed on a display screen of the check-in workstation 500. The check-in workstation 500 is securely connected to the core system 800 over the network 250.

The travel information and the traveler's identity, is matched with the identity information contained in the identity token, and the agent may further verify the identity of the individual biometrically by comparing a facial image stored in the core system 800 and displayed on the display screen at the check-in workstation 500 with the individual presenting the identity token. The agent may also verify, by accessing a transportation facility database 580 connected to the check-in workstation 500 through the network 250, the travel information and whether the ticket has been paid for by the individual, and may issue a boarding pass and luggage tags. The check-in information, such as travel time, travel vehicle number, estimated schedule, and ways the method of payment used for purchase of the ticket, establishes a record that is transmitted to and stored in a memory of the core system 800 via the secure network 250 to allow access and tracking of this information from other workstations during further stages of the identity management system.

In an exemplary embodiment, the check-in workstation 500, unlike a traditional check-in station, allows for biometrically recognizing the individual based on the data encoded in the identity token and the biometric data read from the individual at the check-in workstation 500 and comparing that information to data stored in the core system 800. Once a satisfactory comparison is made, for instance when the facial image that was stored in the core system 800 and displayed at the check-in workstation 500 corresponds to the individual, the individual's identity is confirmed, and the individual is allowed to check-in. Thus, no further identification may be required to check-in, as all the necessary and verifiable information is contained in the identity token.

In another exemplary embodiment of the check-in workstation 500 according to this invention, an automated check-in kiosk 550, as shown in FIG. 1, is interconnected to the core system 800 through the network 250. The check-in kiosk 550 is used to perform the same function as performed at the check-in workstation 500 with the difference that there is no need for help from transportation carrier personnel at the check-in kiosk 550. In this embodiment, the identity of the individual is read when the identity token is scanned in the check-in kiosk 550 and the travel information is verified and matched automatically at the check-in kiosk 550. Travel information is also automatically accessed and collected from a transportation facility database 580 to which the check-in kiosk 550 is securely connected through the secure network 250. In other words, a traveler would use the identity token issued at the enrollment workstation 300 to check-in, and obtain a boarding pass from the check-in kiosk 550.

The check-in kiosk 550 may be used to automatically verify the identity of the individual through the biometric data encoded on the identity token and comparing the biometric data with such data read from the individual at the kiosk using a fingerprint scanner, an iris scanner, a video recorder, and the like. The check-in kiosk 550 also automatically accesses the information already stored in the core system 800 to compare the information read in the identity token when it is scanned through an identity token scanner, as well as the biometric data provided by the individual at the check-in kiosk 550 to the data present in the core system 800. Once a satisfactory comparison is made, the individual's identity is confirmed, and the individual is allowed to check-in. The check-in kiosk 550 is securely connected to the core system 800 over a network 250 and to the transportation facility database 580, as shown in FIG. 1. The check-in information, such as travel time, travel vehicle number, estimated schedule, and ways in which the ticket was paid, establish a permanent record and is transmitted to and stored in a memory of the core system 800 via the secure network 250 to allow access and tracking of this information from other workstations during further stages of the identity management system.

In an exemplary embodiment of this invention, identity verification may also occur at one or more security workstations 600 located throughout a transportation facility. Each security workstation 600 is interconnected securely to the core system 800 through the network 250. For example, the security workstation 600 may be located at the baggage claim security area in an airport or other areas where controlled access is desired.

In an exemplary embodiment of this invention, the security workstation 600 may consist of a display screen, an identity scanner to read the information encoded in the identity token, a biometric data collection device such as a voice recorder, a fingerprint scanner, an iris scanner, and the like, and a secure link or network to the core system 800 and a computer, either operated by an agent or by the individual, to query the core system 800 to verify the identity of the individual along with the reservation and travel information. The security workstation 600 may also include an agent recording the biometric data from an individual and querying the core system 800 to verify the identity of the individual and the individual's reservation and travel information. Travel information is confirmed by the presentation of valid boarding documents and the query of the core system 800 for the travel information transmitted to and stored in a memory of the core system 800 during check-in.

The security workstation 600 also accesses the identity information already stored in the core system 800 over the secure network 250 to compare the information read in the identity token, as well as the biometric data provided by the individual and read at the security workstation 600, to the data in the core system 800. The information stored in the core system 800 and accessed through the security workstation may be displayed on a display screen of the security workstation 600.

Once a satisfactory comparison is made, for instance when the facial image of the individual, stored in the core system 800 and accessed securely through the security workstation 600, corresponds to the individual's face, then the individual's identity is confirmed, and the individual is allowed to proceed. No other form of identification is required to proceed past the security workstation 600 in view of the information encoded in the identity token and the biometric data read at the security workstation 600. The data recorded at the security workstation 600, such as information read by scanning the individual's identity token, the biometric data provided by the individual and the travel information queried constitute a permanent record for the individual that is then transmitted to and stored in a memory of the core system 800 to allow tracking and access from any workstation securely linked to the core system 800 through the secure network 250 during other stages of the identity management system.

The security workstation 600 may also be used to verify that a worker or employee has a valid reason to access a given area of the facility. The security workstation 600 is used to access an employee's information stored in the core system 800 such as facial image, name and assignment, and the like. An agent, operating the security workstation 600, may match the identity of the employee or worker to information stored in a memory of the core system 800 by accessing the core system 800 through the secure network 250. The agent may also collect biometric data for further identification of the employee or worker, and compare the biometric data collected at the security workstation 600 to the biometric data already stored in a memory of the core system 800 and accessed through the secure network 250 from the security workstation 600.

The employment and identity information will be part of the permanent tracking record of the employee or worker, and is transmitted to and stored in a memory of the core system 800 via the secure network 250 to allow tracking and access from any workstation securely linked to the core system 800 during other stages of the identity management system.

In another exemplary embodiment of this invention, a boarding workstation 700, as shown in FIG. 1, may be used to verify the identity of a passenger and verify that the passenger is confirmed to be aboard the means of transportation. The boarding workstation 700 is interconnected to the core system 800 through the network 250. Biometric data may also be read at the security workstation 700 to determine if the identity of the individual matches the data encoded in the identity token and the data stored in the core system 800.

In an exemplary embodiment of this invention, the boarding workstation 700 may consist of a computer, a display screen and a printer used by an agent or stand-alone, an identity token scanner to read the information encoded in the identity token, a biometric data collection device such as a voice recorder, a fingerprint scanner, an iris scanner, and the like, and a secure network 250 to the core system 800 to access the core system 800 and verify the information read on the identity token and the biometric data provided by the individual at the boarding workstation 700 against the information already stored in a memory of the core system 800 to verify the identity of the individual as well as the individual's reservation and travel information. Once a satisfactory comparison is made, the individual's identity is confirmed, and the individual is allowed to proceed.

The data collected at the boarding workstation 700, such as information read by scanning the individual's identity token, the biometric data provided by the individual at the boarding workstation 700 and the travel information queried from the core system 800 through a secure link or network 250 are transmitted to the core system 800 and constitute a permanent record stored in a memory of the core system 800 to allow access and tracking of this information from other workstations that are securely linked to the core system 800 via the secure network 250.

In another exemplary embodiment of the present invention, boarding may be performed at an automated, stand-alone boarding kiosk 750. The boarding kiosk 750 is similar to the boarding workstation 700, except that it is designed to be used by the passenger without help from transportation carrier personnel. In this embodiment, the identity of the individual read when the identity token is scanned using an identity token scanner in the boarding kiosk 750, and the travel information, are verified and matched automatically at the boarding kiosk 750. Travel information is queried from a transportation facility database 580 to which the boarding kiosk 750 is securely connected through the secure network 250. The information read at the boarding kiosk 750 and the biometric data provided by the individual at the boarding kiosk 750 are compared automatically to information already stored in a memory of the core system 800, which is accessed from the boarding kiosk 750 over the secure network 250. Verification of the identity of the individual is then automatically carried out. Any updated travel information, with any new itinerary, transport carrier and whether the ticket has been paid, is also transmitted to the core system 800 over the secure network 250 and stored in a memory of the core system 800. This information is stored in a memory of the core system 800 to allow access and tracking of this information from other workstations during other stages of the identity management system, and establish a permanent record of the travel history of the individual.

In an exemplary embodiment of this invention, fraudulent use of an identity token is prevented on at least three different occasions. The first occasion is during pre-enrollment 100. The individual, when applying to the identity management system, is asked “out of wallet” questions that are picked from several financial organizations such as credit reporting agencies, credit card companies, banks, and the like. The questions asked can be the individual's monthly mortgage payment, the banks where the individual might have accounts, and the like. The second occasion is when the individual files the application, the individual may submit a small credit card payment to cover the costs of the application. The credit card information submitted by the individual is recorded and further financial information is accessed. The financial information thus gathered may be used to generate more questions to ask the individual, for instance during enrollment. The third occasion is during authentication and, as described above, background checks are performed with the help of law enforcement databases 201, background checking organizations 202 or other organizations such as the Transportation Security Administration (TSA), and the like.

In another exemplary embodiment of this invention, the functions performed by the workstations described above, may be performed by a single workstation, or by a plurality of workstations distributed throughout the transportation facility. The number of workstations participating in this identity management system may depend on the size of the transportation facility, on the number of travelers using the transportation facility, the number of employees or workers, and the like.

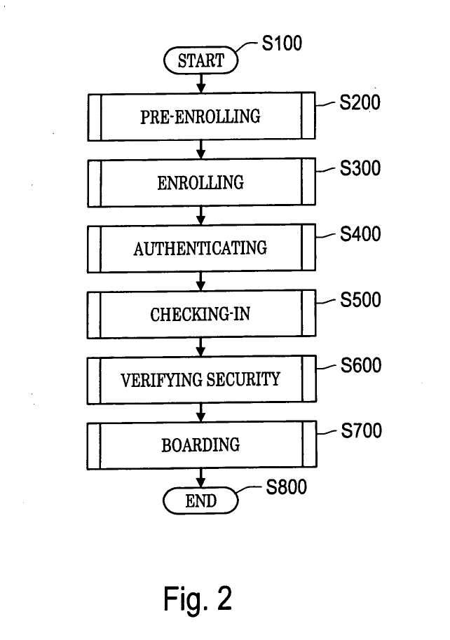

FIG. 2 is a flowchart illustrating an exemplary identity management method according to this invention. In an exemplary embodiment, operation of the identification management process begins at step S100 and proceeds to step S200 with pre-enrolling. During the pre-enrolling step S200, an individual applicant provides personal data, such as name, date of birth, citizenship, address, and the like, agrees to certain contractual terms, answers to a few questions and may request specific access privileges. In the case of a transportation facility worker or employee, the individual must also visit the nearest transport facility, or other authorized location, to submit a biometric data sample, such as a fingerprint, facial image, iris scan, hand geometry, voice print, and the like. The pre-enrolling step S200 is followed by an enrolling step S300.

Step S300 includes the individual providing further identification documentation, such as passport, driver's license, and the like, to the transportation facility, or other authorized location. The information provided is verified against the information collected during the pre-enrolling step S200. Biometric data may also be collected from the individual during step S300. Such biometric data may include fingerprints, iris or retinal scan, voice print, facial image, and the like. Operation of the method proceeds to step S400 authenticating.

During step S400 the information obtained during steps S200 and S300 is vetted by the proper agencies to verify the identity of the individual. Upon successful completion at step S400, an identity token may be issued to the individual that includes verified identity and/or biometric information encoded on it. Alternatively, a drivers license, passport, or other means of identification may be approved for use as an identity token in the identity management system.

The checking-in step S500 includes the enrolled individual using the identity token to check-in at a transportation facility prior to travel. The checking-in step S500 also consists in the individual submitting biometric data such as a facial image, fingerprint, or the like. This data is then compared to biometric data encoded in the identity token and to biometric data stored in the core system 800 and securely accessed through the network 250 from the check-in workstation 500 to be displayed on a screen of the check-in workstation 500. The checking-in step S500 may also include check-in of passenger luggage and obtaining luggage tags without any further identification required. Operation continues at step S600.

The verifying security step S600 consists of the verification of the individual's identity through the use of the identity token and the comparison of the information encoded therein to travel information and to information stored in the core system 800. The verifying security step S600 may also consist of the individual submitting biometric data for comparison to the biometric data encoded in the identity token and to biometric data stored in the core system 800 and accessed over the secure network 250 from the security workstation 600 to be displayed on a screen of the security workstation 600. Operation continues at step S700.

The boarding step S700 allows the individual to board a means of transportation with the simple use of the identity token where the information encoded therein is further verified against travel information and enrollment information stored in the core system 800. The boarding step S700 also may consist of the individual submitting biometric data for comparison to the biometric data encoded in the identity token and to biometric data stored in the core system 800 and accessed over the secure network 250 from the boarding workstation 700 to be displayed on a screen of the boarding workstation 700. Operation of the method then continues to step S800, where operation ends.

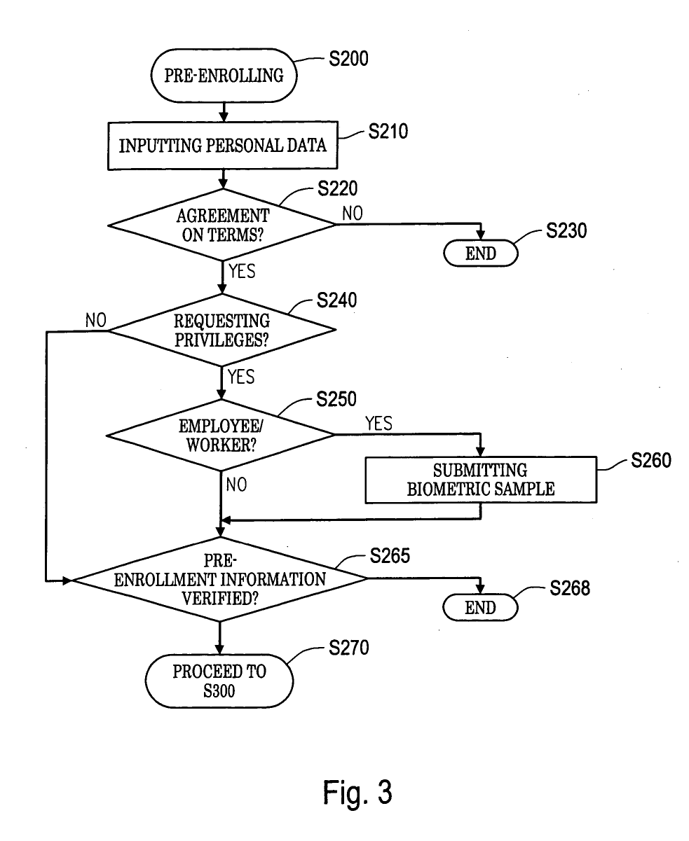

FIG. 3 is a flowchart illustrating an exemplary method of the passenger/employee pre-enrollment step S200 shown in FIG. 2. The process begins at the pre-enrolling step S200 and continues to the inputting step S210. During this step, the individual files an application for enrollment into the identity management system and provides personal data such as name, date of birth, address, and the like, answers a few questions, agrees to certain contractual terms, and may request specific access privileges. The questions asked to the individual may focus on “out of wallet” topics, i.e., the questions cannot be answered by looking up the information typically present in an individual's wallet such as individual's date of birth or credit card number. In an exemplary embodiment of this invention, the “out of wallet” questions may pertain to some personal financial information, such as exact mortgage payment, whether the individual has a checking account in a given bank, the individual's mother's maiden name, and the like. Following the input step S210, the operation proceeds to step S220.

In the case of a traveler, the individual simply has to agree to participate in the identity management system. In the case of a transportation facility employee or worker, the individual has to specifically agree on the terms of the identification management system in relation to the individual's terms of employment. Following the contractual terms agreement step S220, the operation proceeds to either step S230 or step S240, depending upon the response the individual provides during step S220.

If an individual refuses to agree to contractual terms, the operation proceeds to step S230 where the process ends. If the individual agrees to the contractual terms, the operation proceeds to step S240. In the case of a traveler, the individual simply has to decline to request any specific privileges such as access to certain areas of the facility, and the like, to proceed to step S265. In the case of a transportation facility employee or worker, the individual may specify access to certain areas of the facility and must submit a biometric sample, step S260.

During the submitting biometric sample step S260 the individual submits a biometric sample such as a facial image, a fingerprint, a voice print, an iris scan, hand geometry, and the like. Following either step S240 or step S260 for a traveler or an employee respectively, operation proceeds to step S265.

Step S265 consists of verification and processing of the information collected during pre-enrollment. If the information is satisfactorily verified and processed the next stage of the identity management process continues to step S270 where the individual is requested to enroll. If the information is not successfully verified and processed, then the operation proceeds to step S268 where operation ends.

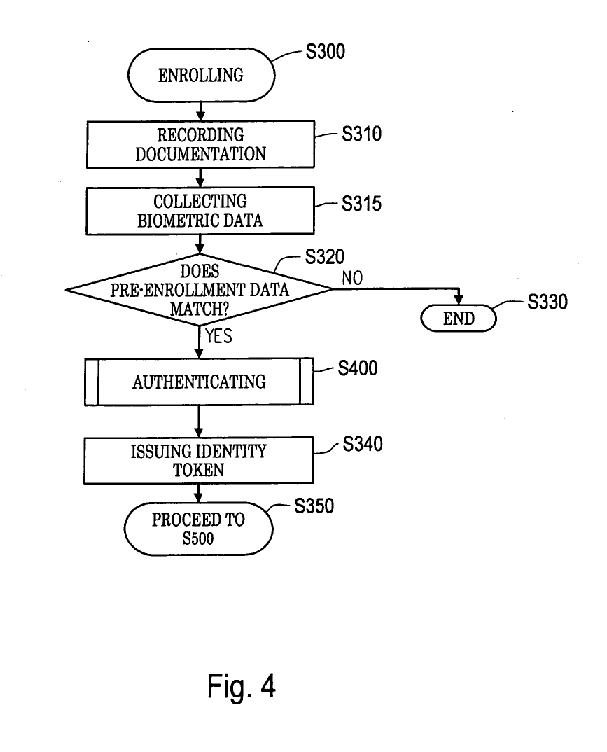

FIG. 4 is a flowchart illustrating an exemplary method of the passenger/employee enrollment step according to this invention. As shown in greater detail in FIG. 4, the individual visits the transportation facility, or any other authorized location, and brings further documentation, such as a passport, birth records, driver's license, and the like. During the recording documentation data step S310, images of the documentation are recorded. The recorded documentation is transmitted to the core system 800 and stored in a memory of the core system 800 to which the enrollment workstation 300 is securely connected through the secure network 250.

During step S315, biometric data is submitted by the individual, such as facial image, fingerprints, iris scans, and the like. The biometric data collected during step S315 is transmitted to the core system 800 through the secure network 250 and stored in a memory of the core system 800 to constitute a permanent record and reference of the individual. Following the collecting biometric data step S415, the identification system continues on to step. S320.

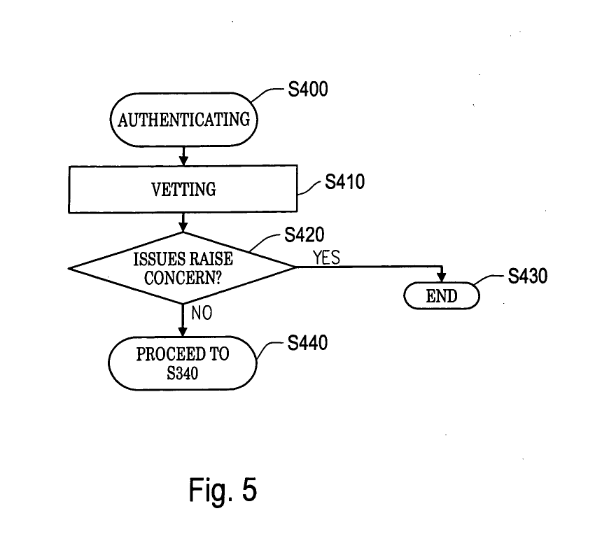

During step S320, a match is determined between the information provided by the individual during pre-enrollment and the information provided during enrollment by querying the core system 800 to which the enrollment workstation 300 is securely connected through the secure network 250. If the information presented by the individual does not match the information submitted by the individual during the pre-enrollment step S200, then operation ends at step S330. If the information presented by the individual does match the information submitted during the pre-enrollment step S200, then operation continues to the authenticating step S400 (FIG. 5).

During the authenticating step S400, the personal data submitted by an applicant during the pre-enrolling step S200 and the enrolling step S300 is verified against a number of data sources such as the FBI, the INS, Interpol, or any other relevant government agency and/or background/security checking during the vetting step S410. Following step S410, the operation continues at step S420.

During step S420, if a background security check reveals concern, such as outstanding legal or immigration issues, the identification system proceeds to step S430 where operation ends. During step S420, if a background check does not reveal any concerns, operation continues at step S440 where operation continues at step S340.

During step S340, an identity token is issued. In an exemplary embodiment of the token, the appropriate personal and biometric data of the individual is encoded. In the case of a traveler, the identity token also contains information identifying the individual as a registered passenger. In the case of an employee or worker, the identity token also contains information identifying the individual as a registered and valid employee or worker. Following the issuing identity token step S340, operation continues at step S350.

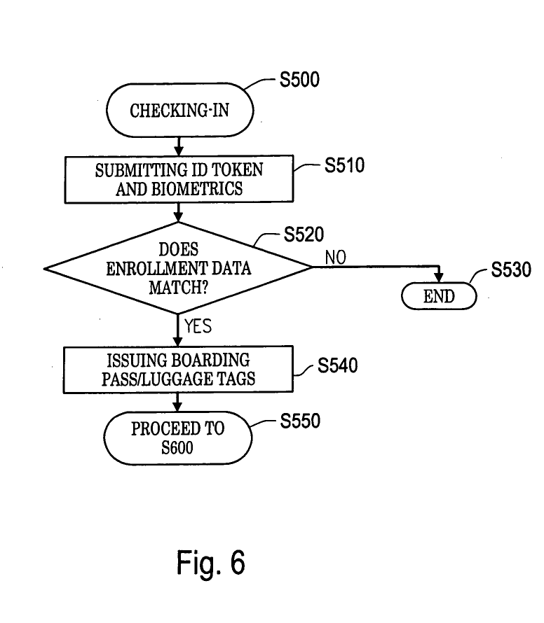

During step S350, the individual is allowed to proceed to the following step in the identity management system, the check-in step S500 (FIG. 6).

FIG. 6 is a flowchart illustrating an exemplary method of check-in according to this invention. As shown in greater detail in FIG. 6, the individual presents the identity token during step S510. The individual also provides biometric information, which is read at the check-in workstation 500. During this step, the identity token is scanned in the check-in workstation 500 by a transportation facility agent or by the individual at a check-in kiosk 550. The identification token is read at the check-in workstation 500 during step S510 to acquire personal and travel information, encoded in the token and stored in the core system 800, pertaining to the individual. Following step S510, operation continues at step S520.

During step S520, information in the identification token is read and a determination is made to verify that the token information matches the information encoded on the token and stored in the core system 800. Biometric data, such as a facial image, may also be verified against data stored in the core system 800. If a match occurs, then operation proceeds to step S540 and no further identification is needed during check-in. If the information read in the identification token does not match the information stored in the core system 800, then operation proceeds to step S530 where operation ends.

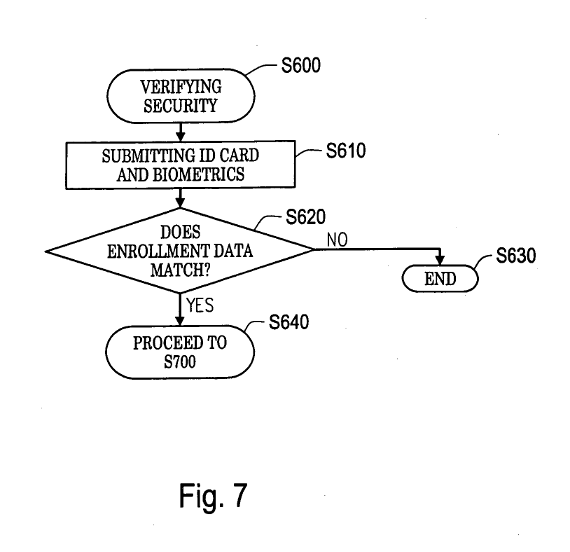

During step S540, the individual may be issued boarding passes and luggage tags. Check-in can either be carried out at a check-in workstation 500 manned by transportation carrier personnel or at a check-in kiosk 550 where the traveler is identified without help from transportation carrier personnel. Following the issuance of a boarding pass and luggage tags step during S540, operation continues at step S550. During this step, the individual is allowed to proceed to the next step which is the security step S600 (FIG. 7). The information collected during steps S5 10 through S550 is transmitted to the core system 800 through the secure network 250 and stored in a memory of the core system 800 for access during other stages of the identity management system from other workstations.

FIG. 7 is a flowchart illustrating an exemplary method of the security check-step according to this invention. During the security step S600, the identity of the traveler and purpose of the traveler's presence are further verified at the security workstation 600. The identity token is read at the security workstation 600 using an identity token scanner, during step S610. In an exemplary embodiment, the identity token maybe scanned by the individual. In another embodiment, the identity token may be scanned by a transportation facility agent. The individual may also provide biometric information, which is read at the security workstation 600. Following step S610, the identity management system continues on to step S620.

During step S620, information stored in the core system 800 is accessed through the secure network 250. If the information read in the identification token does not match the information stored in the core system 800, the biometric data such as a facial image and information provided at the security workstation 600, or the travel information such as a valid and current reservation, which is also recorded in the core system 800, then operation proceeds to step S630 where operation ends.

In the case of a worker or employee, during step S620 and through the use of the security workstation 600, it is determined whether that employee has a valid and current reason for being in a given area of the transportation facility. If the information read in the identification token matches the information stored in the core system 800, the biometric data and information provided at the security workstation 600, then operation proceeds to step S640.

During this step, the individual is allowed to proceed to the boarding area. The information collected during steps S610 through S640 is transmitted to the core system 800 through the network 250 and stored in a memory of the core system 800 for access during other stages of the identity management system through other workstations.

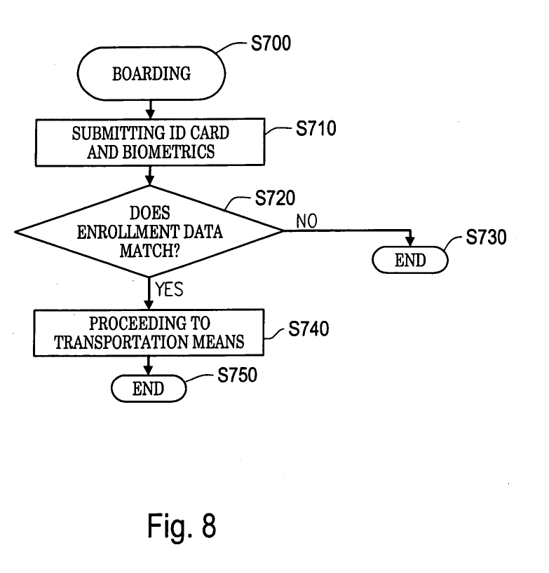

In another exemplary embodiment of this invention, following the security step S600, boarding may be performed during the boarding step S700, as shown in greater detail in FIG. 8. FIG. 8 is a flowchart illustrating an exemplary method of the boarding step according to this invention. The identity token is presented at the boarding workstation 700 during step S710 for boarding a means of transportation and no further identification is needed. In an exemplary embodiment, the identity token may be scanned by the individual. In another embodiment, the identity token may be scanned by a transportation facility agent. The individual may also provide biometric information, which is read at the boarding workstation 700 or kiosk 750. Following step S710, operation continues at step S720.

During step S720, the information stored in the core system 800, is accessed through the secure network 250. If the information read in the identification token does not match the information stored in the core system 800, the biometric data such as a facial image and information provided at the boarding workstation 700, or the travel information such as a valid and current reservation, which is also recorded in the core system 800, then operation proceeds to step S730 where operation ends.

During step S730, the identification system is interrupted and the individual may be prevented from proceeding any further. The individual may be prevented from boarding transportation means. If the information read in the identification token matches the information which is recorded in the core system 800, the biometric data and information provided at the boarding workstation 700, and the travel information such as a valid and current reservation, which is also recorded in the core system 800, then operation proceeds to step S740.

During step S740, the individual is allowed to board onto the means of transportation. Following step S740, the identity management system continues on to step S750 where operation proceeds to the end of the identification management process at step S800. The information collected during steps S710 through S750 is transmitted to the core system 800 through the secure network 250 and stored in a memory of the core system 800 for access from other workstations.

If operation ends in any of the above steps because the information read on the token and/or the biometric presented by an individual fails to match the other, and/or the information stored in the core system 800, then the identification management system may also provide for the notification of authorities to take the appropriate action. Similarly, if operation ends in any of the above processes for reasons other than successful completion of the process, then authorities may be notified to take the appropriate action.

The network 250 can be implemented using any known or later developed device or system for connecting the one or more workstations to the core system including a direct cable connection, a connection over a wide area network or a local area network, a connection over an intranet, a connection over the Internet, or a connection over any other distributed processing network or system. In general, each of the network can be any known or later developed connection system or structure usable to connect one or more of the workstations.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made to the invention without departing from the spirit and scope thereof.

What is claimed is:

1. An identity management system to authenticate the identity of an individual, comprising:
a vetting workstation to verify the identity of the individual and generate identification data;
an enrollment workstation to enroll the individual whose identity has been verified, to issue an identification token, and generate identification data; and
a core system networked with the vetting workstation and the enrollment workstation to provide a central clearinghouse for the storage and exchange of identification data.

2. The identity management system of claim 1, further comprising a security check workstation to validate the identity of the individual at a facility using the. identification token, and to record identification data, wherein the core system is networked with a security check workstation.

3. The identity management system of claim 1, further comprising a check-in workstation for checking-in individuals possessing the identification token, wherein the core system is networked with the checking workstation.

4. The identity management system described in claim 3, wherein the check-in workstation is an automated kiosk.

5. The identity management system described in claim 1, further comprising a dispatch workstation to allow tracking of an individual with respect to the facility, to verify the individual's employee status, and to verify that the individual has a need to access certain areas of the facility, wherein the core system is electronically connected with the dispatch workstation.

6. The identity management system described in claim 1, further comprising a boarding workstation to authorize an individual to board a means of transportation based on verification of the identity and travel information regarding the individual, wherein the core system is electronically connected to the boarding workstation.

7. The identity management system described in claim 1, wherein the core system is electronically connected with the vetting workstation and the enrollment workstation using a secure connection.

8. The identity management system described in claim 6, wherein the core system is networked with the check-in workstation and the boarding workstation using a secure connection.

9. The identity management system described in claim 5, wherein the core system is networked with the dispatch workstation using a secure connection.

10. The identity management system described in claim 3, further comprising a boarding workstation to authorize an individual to board a means of transportation based on verification of the identity and travel information regarding the individual, wherein the core system is electronically connected to the boarding workstation.

11. An identity management process for authenticating the identity of an individual, comprising:
pre-enrolling the individual in an identity management system by collecting personal information submitted by the individual and storing the information in a database;
vetting the individual by authenticating the personal information through at least one database of at least one of law enforcement, government and background checking organizations;
enrolling the individual into the identity management system;
comparing personal information collected during pre-enrolling to data collected during enrolling;
vetting the individual by conducting at least a background check of the individual; and
issuing an identification token to the individual.

12. The identity management process of claim 11, wherein pre-enrolling employs at least one of the Internet, mail service, and personal appearance.

13. The identity management process of claim 11, further comprising submitting biometric data for identification purposes.

14. The identity management process of claim 11, further comprising checking-in the individual at a location by at least one of scanning the identification token of the individual, verifying biometric data of the individual and querying the core system for identity data.

15. The identity management process of claim 11, further comprising conducting security checks at least one location using a security workstation by at least one of scanning the identity token of the individual, verifying biometric data of the individual and querying the core system for identity data.

16. The identity management process of claim 11, further comprising identity verification prior to boarding a means of transportation by at least one of scanning the identification token of the individual, verifying biometric data of the individual and querying the core system for identity and travel information.

17. The identity management process of claim 14, wherein checking-in includes obtaining the identity information queried from the core system that includes at least one of a facial image, an iris scan, hand geometry, a fingerprint, and the like.

18. The identity management process of claim 15, wherein conducting security checks includes obtaining identity information queried from the core system that includes at least one of a facial image, an iris scan, hand geometry, a fingerprint, and the like.

19. The identity management process of claim 16, wherein identity verification includes obtaining identity information queried from the core system includes at least one of a facial image, an iris scan, hand geometry, a fingerprint, and the like.

20. The identity management process of claim 11, wherein pre-enrolling, enrolling and vetting are performed in accord with an access control system of a transportation facility.

21. A computer usable program embodied on a computer usable medium having computer readable program code means, comprising:
pre-enrolling an individual in the identity management system by recording personal information submitted by the individual;
enrolling the individual into the identity management system;
vetting the individual by authenticating personal data through the query of a plurality of databases including law enforcement, government and background checking organizations; and
issuing an identity token to the individual.

22. The computer program of claim 21, wherein pre-enrolling employs at least one of the Internet, mail service, and personal appearance.

23. The computer program of claim 21, further comprising submitting biometric data.

24. The computer program of claim 21, further comprising checking-in the individual by at least one of scanning the identity token of the individual, verifying biometric data of the individual and querying the core system for identity information.

25. The computer program of claim 21, further comprising conducting security checks at various locations using one or more security workstations by at least one of scanning the identity token of the individual, verifying biometric data of the individual and querying the core system for identity information.

26. The computer program of claim 21, further comprising boarding onto the means of transportation by at least one of scanning the identity token of the individual, verifying biometric data of the individual and querying the core system for identity and travel information.
